(19) United States
(12) Patent Application Publication
(10) Pub. No.: US 2018/0326518 A1
(43) Pub. Date: Nov. 15, 2018

(54) SAW WIRE AND CUTTING APPARATUS

(71) Applicant: PANASONIC INTELLECTUAL PROPERTY MANAGEMENT CO., LTD., Osaka (JP)

(72) Inventors: Tomohiro KANAZAWA, Osaka (JP); Masato WADA, Hyogo (JP); Takayuki IMAI, Osaka (JP); Tetsuji SHIBATA, Osaka (JP); Kazushige SUGITA, Hyogo (JP); Naoki KOHYAMA, Osaka (JP); Hiroshi GOUDA, Osaka (JP); Yoshitaka MIZUGUCHI, Osaka (JP)

(73) Assignee: PANASONIC INTELLECTUAL PROPERTY MANAGEMENT CO., LTD., Osaka (JP)

(21) Appl. No.: 15/975,140

(22) Filed: May 9, 2018

(30) Foreign Application Priority Data
May 10, 2017 (JP) 2017-094230

(51) Int. Cl. B23D 61/18; B21C 1/00

(52) U.S. Cl. CPC B23D 61/185; C22C 27/04; B21C 1/003

(57) ABSTRACT

A saw wire and various methods of use and manufacture are provided. The saw wire includes a metal wire containing one of tungsten and a tungsten alloy. A surface roughness Ra of the metal wire is at most 0.15 μm. A diameter of the metal wire is at most 60 μm.

### CROSS REFERENCE TO RELATED APPLICATION

This application claims the benefit of priority of Japanese Patent Application Number 2017-094230 filed on May 10, 2017, the entire content of which is hereby incorporated by reference.

### BACKGROUND

### 1. Technical Field

The present disclosure relates to a saw wire and a cutting apparatus including the saw wire.

### 2. Description of the Related Art

Conventionally, a multi-wire saw for slicing a silicon ingot using wires composed of piano wire, has been known (see reference, for example, to Japanese Unexamined Patent Application Publication. No. 2008-213111).

### SUMMARY

During the slicing operation of a wire saw, swarf is produced in an amount approximately corresponding to the wire diameter. The aforementioned multiwire saw uses wires composed of piano wire, however, it is difficult to reduce the diameter size of piano wire. More specifically, it is difficult, in the present conditions, to manufacture piano wire having a diameter less than 60 μm. In addition, since piano wire has an elastic modulus of at least 150 GPa and at most 250 GPa, even if the piano wire could be thinned, deflection still occurs during the slicing process. Therefore, thinned piano wire is unsuitable for use in wire-saw slicing.

In view of the above, an object of the present disclosure is to provide a saw wire capable of reducing kerf loss of an object to be cut, and a cutting apparatus including the saw wire.

In order to achieve the above-described object, a saw wire according to an aspect of the present disclosure includes a metal wire containing at least one of tungsten and a tungsten alloy. A surface roughness Ra of the metal wire is at most 0.15 μm, and a diameter of the metal wire is at most 60 μm.

In addition, a cutting apparatus according to an aspect of the present disclosure includes the saw wire.

In addition, a method of slicing an ingot according to an aspect of the present disclosure includes: moving at least one saw wire relative to the ingot, each saw wire including a metal wire containing at least one of tungsten and a tungsten alloy, a surface roughness Ra of the metal wire being at most 0.15 μm, and a diameter of the metal wire being at most 60 μm; and dividing the ingot at least into partly-sliced portions by the at least one saw wire.

In addition, a method of manufacturing a saw wire according to an aspect of the present disclosure includes forming a metal wire containing at least one of tungsten and a tungsten alloy. In the method, a surface roughness Ra of the metal wire is at most 0.15 μm, and a diameter of the metal wire is at most 60 μm.

According to the present disclosure, it is possible to provide a saw wire capable of reducing kerf loss of an object to be cut, and a cutting apparatus including the saw wire.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a perspective diagram which illustrates a cutting apparatus according to an embodiment;

FIG. 2 is a cross-sectional view which illustrates how an ingot is sliced by the cutting apparatus according to the embodiment;

FIG. 3 is a cross-sectional diagram which illustrates a saw wire according to the embodiment;

FIG. 4 is a state transition diagram which illustrates the process of manufacturing a metal wire which is thinned, in a method of manufacturing the saw wire according to the embodiment;

FIG. 5 is a state transition diagram which illustrates the process of fixing abrasive particles to the metal wire, in the method of manufacturing the saw wire according to the embodiment; and

FIG. 6 is a diagram which illustrates a relationship between the surface roughness Ra of the metal wire which forms the saw wire according to the embodiment, the degree of detachment of an abrasive particle, and the adhesion of nickel plating layer.

### DETAILED DESCRIPTION OF THE EMBODIMENTS

The following describes in detail a saw wire and a cutting apparatus according to an embodiment of the present disclosure, with reference to the drawings. It should be noted that the embodiment described below indicates one specific example of the present disclosure. The numerical values, shapes, materials, structural components, the disposition and connection of the structural components, etc. described in the following embodiment are mere examples, and do not intend to limit the present disclosure. Furthermore, among the structural components in the following exemplary embodiment, components not recited in the independent claim which indicates the broadest concept of the present invention are described as arbitrary structural components.

In addition, each diagram is a schematic diagram and not necessarily strictly illustrated. Accordingly, for example, scale sizes, etc., are not necessarily exactly represented. In each of the diagrams, substantially the same structural components are assigned with the same reference signs, and redundant descriptions wilt be omitted or simplified.

In addition, a term, such as “parallel” or “equal”, representing a relationship between the components as well as a term, such as “circular”, representing a form, and a numerical range arc used in the present description.. Such terms and range are each not representing only a strict meaning of the term or range, but implying that a substantially same range, e.g., a range that includes even a difference as small as a few percentage points, is connoted in the term or range.

### Embodiment

(Cutting Apparatus)

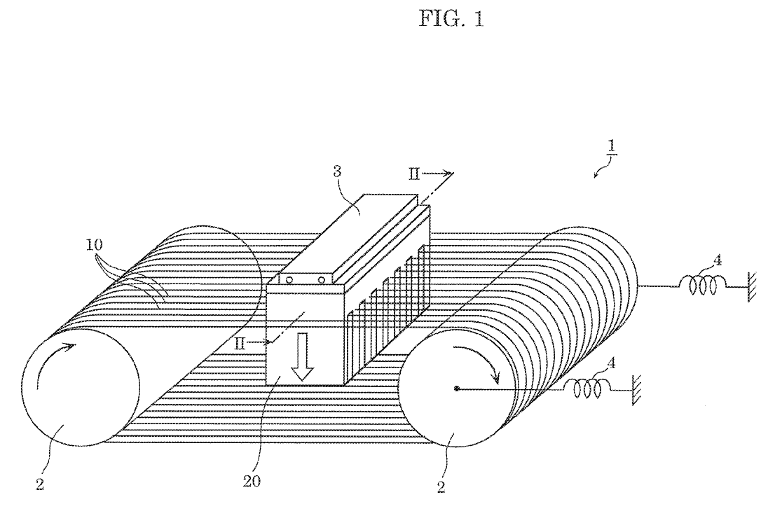

First, an overview of a cutting apparatus including a saw wire according to the present embodiment will be described with reference to FIG. 1, FIG. 1 is a perspective view illustrating cutting apparatus 1 according to the present embodiment.

As illustrated in FIG. 1, cutting apparatus 1 is a multi-wire saw including saw wire 10. Cutting apparatus 1 produces wafers by, for example, cutting ingot 20 into thin slices. Ingot 20 is, for instance, a silicon ingot including single-crystal silicon. More specifically, cutting apparatus 1 simultaneously produces silicon wafers by slicing ingot 20 using saw wire 10.

It should be noted that ingot 20 is a silicon ingot but is not limited to such. For example, an ingot including other substance such as silicon carbide or sapphire may be used. Alternatively, an object to be cut by cutting apparatus 1 may be concrete, glass, etc.

As illustrated in FIG. 1, cutting apparatus 1 further includes two guide rollers 2, ingot holder 3, and tension releasing device 4.

A single saw wire 10 is looped multiple times over two guide rollers 2. Here, for convenience of explanation, one loop of saw wire 10 is regarded as one saw wire 10, and it is assumed that a plurality of saw wires 10 are looped over two guide rollers 2. Stated differently, in the description below, the plurality of saw wires 10 form a single continuous saw wire 10. It should be noted that the plurality of saw wires 10 may be a plurality of saw wires that are separated from one another.

Each of guide rollers 2 rotates in the state in which saw wire 10 is straightly tightened with a predetermined tension, and thereby causes saw wire 10 to rotate at a predetermined speed. Saw wires 10 are disposed in parallel to one another and are equally spaced. More specifically, each guide roller 2 is provided with grooves positioned at predetermined intervals for saw wires 10 to fit in. The intervals between the grooves are determined according to the thickness of the wafers desired to be sliced off. The width of the groove is substantially the same as diameter φ of saw wire 10.

Tension releasing device 4 is a device that releases tension exerted on saw wire 10. Tension releasing device 4 is, for example, an elastic body such as a coiled or plate spring. As illustrated in FIG. 1, tension releasing device 4 that is a coiled spring, for example, has one end connected to guide roller 2 and the other end fixed to a predetermined wall surface. Tension releasing device 4 is capable of releasing the tension exerted on saw wire 10, by adjusting the position of guide roller 2.

It should be noted that cutting apparatus 1 may include three or more guide rollers 2. Saw wires 10 may be looped over three or more guide rollers 2.

Ingot holder 3 holds ingot 20 which is an object to be cut. Ingot holder 3 pushes ingot 20 through saw wires 10, and thereby ingot 20 is sliced by saw wires 10.

It should be noted that, although not illustrated in the diagram, cutting apparatus 1 may include a feeder that feeds a cutting fluid such as a coolant to saw wires 10.

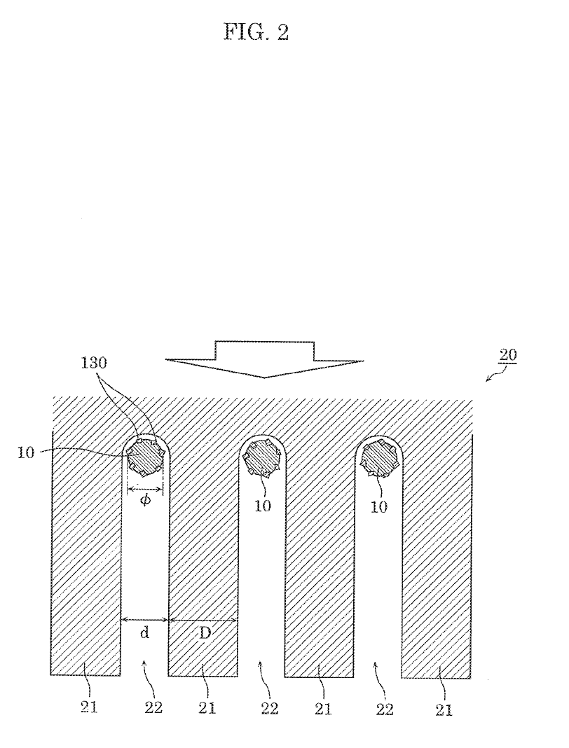

FIG. 2 is a cross-sectional view which illustrates how ingot 20 is sliced by cutting apparatus 1 according to the present embodiment. FIG. 2 illustrates a cross section that is taken along the line II-II illustrated in FIG. 1 and that is orthogonal to the extending direction of saw wire 10. More specifically, FIG. 2 illustrates how three saw wires 10 among saw wires 10 slice ingot 20.

By pushing ingot 20 through saw wires 10, ingot 20 is simultaneously divided into partly-sliced portions 21 by saw wires 10. Space 22 between neighboring partly-sliced portions 21 is a space made by ingot 20 being scrap off by saw wire 10. In other words, the size of space 22 is equivalent to a kerf loss of ingot 20.

Width d of space 22 depends on diameter φ of saw wire 10. Stated differently, width d increases as diameter φ of saw wire 10 becomes larger, and thereby, the kerf loss of ingot 20 increases. Width d decreases as diameter φ of saw wire 10 becomes smaller, and thereby, the kerf loss of ingot 20 decreases.

More specifically, width d of space 22 becomes greater than diameter φ. The difference between width d and diameter φ depends or the size of abrasive particles 130 fixed to saw wire 10 and the oscillation width of the vibrations caused when saw wire 10 rotates around guide rollers 2.

It should be noted that thickness D of partly-sliced portion 21 depends on the intervals at which saw wires 10 are disposed. Accordingly, wire saws 10 are disposed at intervals each resulting from adding desired thickness D and a predetermined margin. More specifically, a margin is a difference between width d and diameter φ, and is a value determined in accordance with the oscillation width of saw wire 10 and the grain diameter of abrasive particle 130.

Based on what has been described above, diameter φ of saw wire 10 is a significant parameter in order to reduce the kerf loss of ingot 20. More specifically, by decreasing diameter φ of saw wire 10, the kerf loss of ingot 20 can be reduced.

The following describes the structure and manufacturing method of saw wire 10.

(Saw Wire)

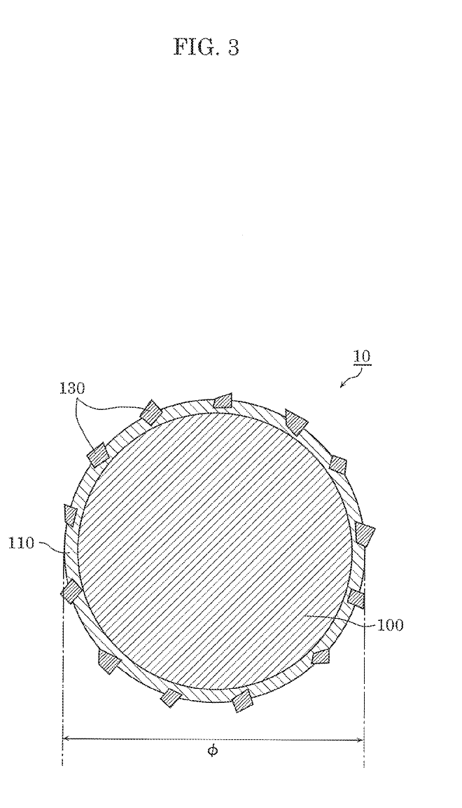

FIG. 3 is a cross-sectional diagram illustrating saw wire 10 according to the present embodiment. More specifically, FIG. 3 is an enlarged view which illustrates a cross section orthogonal to the extending direction of saw wire 10.

As illustrated in FIG. 3, saw wire 10 includes metal wire 100 and nickel plating layer 110. In addition, saw wire 10 includes a plurality of abrasive particles 130 provided to a surface of saw wire 10. It should be noted that diameter φ of saw wire 10 is a sum of a diameter of metal wire 100 and nickel plating layer 110.

Metal wire 100 is a metal thin wire which includes tungsten (W) and is extremely fine. Metal wire 100 comprises pure tungsten. More specifically, the degree of purity of tungsten is 99.9% or higher.

Metal wire 100 which contains tungsten has a strength per an area of cross-section that increases with a decreasing diameter. Accordingly, use of metal wire 100 which contains tungsten makes it possible to implement saw wire 10 having small diameter and a high strength, and to reduce a kerf loss of ingot 20.

In addition, an elastic modulus of metal wire 100 is at least 350 GPa and at most 450 GPa. It should be noted that the elastic modulus is longitudinal elastic modulus. In other words, metal wire 100 has an elastic modulus approximately twice as high as that of piano wire.

The diameter of metal wire 100 is, for example, at most 60 μm. It should be noted that metal wire 100 which contains tungsten has a strength per an area of cross-section that increases as metal wire 100 becomes thinner; that is, increases with a decreasing diameter. For example, the diameter of metal wire 100 may be less than or equal to 50 μm or less than or equal to 40 μm. For example, the diameter of metal wire 100 is 20 μm, but may be 10 μm. It should be noted that, in the case where abrasive particles 130 are to he included as in the present embodiment, the diameter of metal wire 100 is, for example, greater than or equal to 10 μm.

Metal wire 100 is formed to be uniform in diameter. Note that diameter of metal wire 100 may not be entirely uniform and the size of diameter may slightly differ by approximately a few percentage points, e.g., 1%, depending on the portion of metal wire 100. Since the diameter of metal wire 100 is at most 60 μm, metal wire 100 has elasticity and thus can be bent easily to a satisfactory extent. Accordingly, it is possible to easily loop saw wire 10 over and across guide rollers 2.

As illustrated in FIG. 3, metal wire 100 has a circular cross-section shape. However, the cross-section shape of metal wire 100 is not limited to this example. The cross-section shape of metal wire 100 may be rectangular such as square, or oval, or other shape.

Metal wire 100 has a surface roughness Ra of at most 0.15 μm. It should be noted that the surface roughness Ra may be less than or equal to 0.10 μm. In addition, when the surface roughness Ra is excessively small, the adhesion of nickel plating layer 110 decreases, and thus the surface roughness Ra of metal wire 100 may be greater than 0.05 μm, for example.

Nickel plating layer 110 is a plating layer provided over the surface of metal wire 100. Nickel plating layer 110 is a thin-film layer containing nickel (Ni). Nickel plating layer 110 has a thickness of, for example, 1 μm. However, the thickness of nickel plating layer 110 is not limited to this example.

Nickel plating layer 110 tightly and closely covers at least part of the respective abrasive particles 130, and covers the entirely of the surface of metal wire 100 between the plurality of abrasive particles 130. More specifically, as illustrated in FIG. 3, nickel plating layer 110 is provided in an annular shape over the entire circumference of metal wire 100 around an axis of metal wire 100, when viewed in cross-section.

The plurality of abrasive particles 130 are hard particles, such as diamond, cubic boron nitride (CBN), etc. An average grain diameter of the plurality of abrasive particles 130 is less than, or equal to 10 μm, for example. However, the average grain diameter of the plurality of abrasive particles 130 is not limited to this example. The plurality of abrasive particles 130 are each provided to the surface of saw wire 10 by being at least partially affixed firmly to nickel plating layer 110.

(Method of Manufacturing Saw Wire)

The following describes a method of manufacturing saw wire 10 having the above-described features. The method of manufacturing saw wire 10 includes a process of manufacturing metal wire 100 which has a reduced diameter size, and a process of fixing the plurality of abrasive particles 130 to metal wire 100.

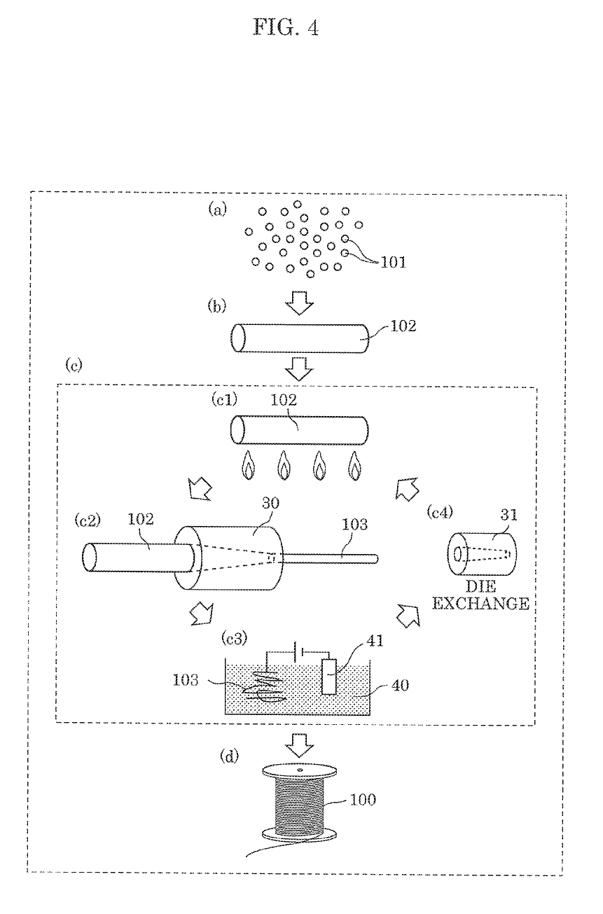

First, the process of manufacturing metal wire 100 will be described with reference to FIG, 4. FIG. 4 is a transition diagram which illustrates the process of manufacturing metal wire 100 which has a reduced diameter size, in the method of manufacturing saw wire 10 according to the present embodiment.

First, tungsten powder 101 is prepared, as illustrated in (a) in FIG. 4. An average grain diameter of tungsten powder 101 is 5 μm, for example. However, the average grain diameter of tungsten powder 101 is not limited to this example.

Next, by pressing and sintering tungsten powder 101, an ingot containing tungsten is produced. By performing, onto the ingot, a swaging processing of extending an ingot by press-forging the ingot from its periphery, tungsten wire 102 having a wire shape is produced, as illustrated in (b) in FIG. 4. For example, tungsten wire 102 having a wire shape has a diameter of approximately 3 mm whereas the ingot containing tungsten that is a sintered body has a diameter of approximately 15 mm.

Next, drawing processing using wire drawing dies is carried out, as illustrated in (c) in FIG. 4.

To be specific, firstly, tungsten wire 102 is annealed, as illustrated in (c1) in FIG. 4. More precisely, tungsten wire 102 is heated not only directly with a burner, but is heated also by applying electrical current to tungsten wire 102. The annealing process is performed in order to eliminate processing distortion generated in the swaging or drawing processing.

Next, drawing of tungsten wire 102 using wire drawing die 30, i.e., wire drawing process, is performed, as illustrated in (c2) in FIG. 4. It should he noted that since tungsten wire 102 is rendered ductile after having been heated in the previous step of annealing process, the wire drawing process can be easily carried out. By reducing the diameter size of tungsten wire 102, the strength of tungsten wire 102 per an area of cross-section becomes higher. In other words, tungsten wire 103 whose diameter size is rendered thinner in the drawing process has a strength per an area of cross-section higher than that of tungsten wire 102. It should be noted that the diameter of tungsten wire 103 is, for example, 0.6 mm, but is not limited to this example.

Next, through the electrolytic polishing of tungsten wire 103 after the drawing process, the surface of tungsten wire 103 is rendered smooth, as illustrated in (c3) in FIG. 4. The electrolytic polishing process is carried out by conducting electricity between tungsten wire 103 and counter electrode 41 such as a carbon rod, in the state in which tungsten wire 103 and counter electrode 41 are bathed into electrolyte 40, e.g., aqueous sodium hydroxide,

Next, die exchange is performed, as illustrated in (c4) in FIG. 4. More specifically, wire drawing die 31 with a pore diameter smaller than that of wire drawing die 30 is selected as a die to be used in the next drawing processing. It should be noted that wire drawing dies 30 and 31 are, for example, diamond dies containing sintered diamond, single-crystal diamond, or the like.

The processes from (c1) to (c4) illustrated in FIG. 4 are repeatedly performed until the diameter of tungsten wire 103 is thinned down to a desired diameter (specifically, less than or equal to 60 μm). At this time, the drawing process illustrated in (c2) in FIG. 4 is performed by adjusting the form as well as hardness of wire drawing die 30 or 31, a lubricant to be used, and the temperature of the tungsten wire, in accordance with the diameter of tungsten wire to be processed.

Similarly, in the annealing process illustrated in (c1) in FIG. 4, annealing conditions are adjusted in accordance with tie diameter of the tungsten wire to be processed. is Through the annealing process, an oxidation product is attached to the surface of the tungsten wire. It is possible to adjust the amount of oxidation products to be attached to the surface of the tungsten wire, by adjusting the annealing conditions,

More specifically, the larger the diameter of the tungsten wire is, at higher temperature the tungsten wire is annealed, and the smaller the diameter of the tungsten wire is, at lower temperature the tungsten wire is annealed. To be more concrete, in the case where the diameter of the tungsten wire is large, for example, the tungsten wire is annealed at the temperature between 1400 degrees Celsius and 1800 degrees Celsius in the annealing process carried out in the first drawing processing. In the final annealing process carried out in the final drawing processing in which the tungsten wire is thinned down to finally have a desired diameter, the tungsten wire is heated at the temperature between 1200 degrees Celsius and 1500 degrees Celsius. It should be noted that, in the final annealing process, electricity need not, be conducted to the tungsten wire.

Moreover, an annealing process may be omitted when a drawing processing is repeated. For example, the final annealing process may be omitted. More specifically, the final annealing process may be omitted and a lubricant as well as the form and hardness of a wire drawing die may be adjusted.

In the drawing process after the final annealing process (i.e., the final drawing process), a single-crystal diamond die containing single-crystal diamond is used as wire drawing die 31. Diamond particles are less likely to be detached in the process using the single-crystal diamond die, and thus a streak is less likely to be formed on the tungsten wire after the drawing process. It is thus possible to reduce the surface roughness Ra of the tungsten wire which has a desired diameter.

In addition, when the drawing process is repeated, drawing is started using the single-crystal diamond die having a pore diameter of 200 μm, when a weight ratio of an amount of oxide included in the tungsten wire having a mass of 50 MG is in a range from 0.2% to 0.5%. In this manner, metal wire 100 having the surface roughness Ra less than or equal to 0.15 μm is manufactured, as illustrated in (d) in FIG. 4.

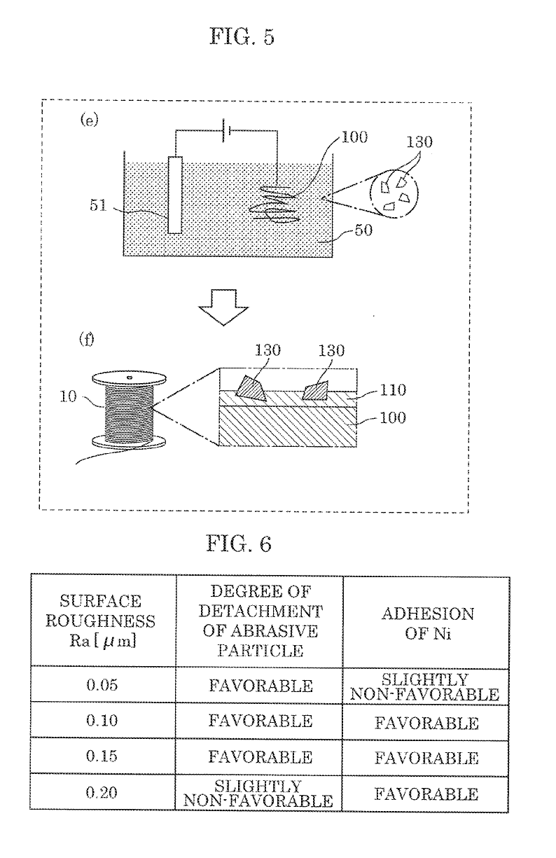

Next, the process of fixing the plurality of abrasive particles 130 to metal wire 100 will be described with reference to FIG. 5. FIG. 5 is a transition diagram which illustrates the process of fixing the plurality of abrasive particles 130 to metal wire 100, in the method of manufacturing saw wire 10 according to the present embodiment. It should be noted that a portion of plating solution 50 and a surface layer portion of metal wire 100 are schematically illustrated in an enlarged manner in (e) in FIG. 5 and in (f) in FIG. 5, respectively.

First, nickel plating layer 110 is formed on a surface of metal wire 100, and abrasive particles 130 are electrodeposited. More specifically, as illustrated in (e) in FIG. 5, electricity is conducted between nickel plate 51 and metal wire 100, in the state where nickel plate 51 and metal wire 100 are bathed into plating solution 50. It should be noted that plating solution 50 is a liquid including nickel sulfate, nickel chloride, and boracic acid. According to the present embodiment, a plurality of abrasive particles 130 are dispersedly mixed in plating solution 50.

In this manner, as illustrated in (f) in FIG. 5, a plurality of abrasive particles 130 are electrodeposited on the surface of metal wire 100, and nickel plating layer 110 is formed so as to fill the gap between the plurality of abrasive particles 130.

With the processes as described above, saw wire 10 is manufactured.

It should be noted that each of FIG. 4 and FIG. 5 schematically illustrates each of the processes of the method of manufacturing saw wire 10. Each of the processes may be performed separately, or may be performed through an in-line process. For example, a plurality of wire drawing dies may be aligned in a descending order of pore diameters in a production line, and heating devices for conducting an annealing process, electrolytic polishing devices, or the like may be placed between the wire drawing dies. In addition, an electrolytic polishing device, a plating device, and a heating device may be sequentially placed in a position subsequent to the wire drawing die having the smallest pore diameter.

(Advantageous Effects, Etc.)

As described above, saw wire 10 according to the present embodiment includes metal wire 100 which contains tungsten, and a surface roughness Ra of metal wire 100 is at most 0.15 μm and a diameter of metal wire 100 is at most 60 μm.

With this configuration, since metal wire 100 contains tungsten., the strength of metal wire 100 increases and thereby tolerance against breakage is improved, as metal wire 100 is rendered thinner. Furthermore, metal wire 100 which contains tungsten is higher in an elastic modulus than piano wire. Since metal wire 100 is high in the strength and elastic modulus, it is possible to loop saw wire 10 over guide rollers 2 with a strong tension. Accordingly, it is possible to reduce the vibrations of saw wire 10 caused during the process of cutting ingot 20.

As described above, since saw wire 10 has a small diameter and is high in the strength and elastic modulus, it is possible to reduce the amount of swarf produced when ingot 20 is sliced, i.e., the kerf loss of ingot 20. Accordingly, it is possible to increase the number of wafers cut out from a single ingot 20.

Moreover, since the surface roughness Ra of metal wire 100 is small, when abrasive particles 130 are fixed to metal wire 100, stress applied to abrasive particles 130 during the process of slicing ingot 20 is easily and uniformly dispersed. Accordingly, it is possible to inhibit detachment of abrasive particles 130 from metal wire 100, and thus a decrease in sharpness of saw wire 10 can be reduced. In addition, stress applied to ingot 20 via abrasive particles 130 can also be easily and uniformly dispersed. Thus, ingot 20 can be smoothly sliced and vibrations of saw wire 10 are reduced, making it possible to reduce the kerf loss of ingot 20.

Here, a relationship between the surface roughness Ra of metal wire 100, the degree of detachment of abrasive particles 130, and the adhesion of nickel plating layer will be described with reference to FIG. 6. FIG. 6 is a diagram which illustrates a relationship between the surface roughness Ra of metal wire 100 included in the saw wire according to the embodiment, the degree of detachment of abrasive particles 130, and the adhesion of nickel plating layer.

As illustrated in FIG. 6, when the surface roughness Ra is at most 0.15 μm, detachment of abrasive particles 130 is reduced. In addition, when the surface roughness Ra is 0.10 μm or 0.05 μm, detachment of abrasive particles 130 is also reduced. Accordingly, stress applied to abrasive particles 130 is more uniformly dispersed with a decrease in the surface roughness Ra, and it can be determined that the adhesion of abrasive particles 130 to metal wire 100 is high. It should be noted that., when the surface roughness Ra is 0.20 μm, detachment of a plurality of abrasive particles 130 occurs.

In contrast, when the surface roughness Ra is excessively small, the adhesion of nickel plating layer 110 decreases. Accordingly, there is a possibility that abrasive particles 130 are detached together with nickel plating layer 110 from metal wire 100. For example, when the surface roughness Ra is 0.05 μm, detachment of nickel plating layer 110 occurs. Accordingly, metal wire 100 may have the surface roughness Ra greater than 0.05 μm and less than or equal to 0.15 μm.

In addition, for example, saw wire 10 further includes a plurality of abrasive particles 130 provided to a surface of metal wire 100.

With this configuration, saw wire 10 can he included in cutting apparatus 1 of a fixed abrasive particle type.

In addition, for example, saw wire 10 further includes nickel plating layer 110 provided to the surface of metal wire 100.

With this configuration, it is possible to enhance the adhesion of a plurality of abrasive particles 130 to metal wire 100.

In addition, cutting apparatus 1 according to the present embodiment includes saw wire 10.

With this configuration, the diameter of saw wire 10 is reduced, and thus it is possible to increase the number of wafers cut out from a single ingot 20. In addition, it is possible to reduce the amount of swarf produced when ingot 20 is sliced.

In addition, for example, cutting apparatus 1 includes tension releasing device 4 which releases tension exerted on saw wire 10.

With this configuration, it is possible to inhibit strong tension from being exerted on saw wire 10. Therefore, it is possible to inhibit breaking off or the like of saw wire 10.

(Variation)

Here, variation examples of the above-described embodiment will be described.

For example, although the case where metal wire 100 contains pure tungsten has been described in the above-described embodiment, the present disclosure is not limited to this example. Metal wire 100 may contain rhenium-tungsten (ReW) alloy.

More specifically, metal wire 100 may contain tungsten as a major component, and a predetermined proportion of rhenium. The rhenium content of metal wire 100 is, for example, at least 0.1 wt % and at most 10 wt % with respect to a total weight of rhenium and tungsten. Although the rhenium content, specifically, is 3 wt %, it may be 1 wt %.

Since metal wire 100 contains rhenium, it is possible to increase the strength of metal wire 100 to be higher than the strength of a pure tungsten wire. With this configuration, metal wire 100 has improved tolerance against breakage even after the thinning process as well as a surface having resistance to scraping. Accordingly, it is possible to easily reduce the surface roughness Ra. In other words, it is possible to easily manufacture metal wire 100 having the surface roughness Ra of at most 0.15 μm.

It should be noted that, although rhenium-tungsten (ReW) alloy is described as the tungsten alloy, the tungsten alloy may be nickel-tungsten (NiW) alloy.

In addition, for example, metal wire 100 of saw wire 10 may be doped with potassium (K).

The metal wire which contains tungsten and is dope with potassium (K) (hereinafter referred to as a potassium-doped tungsten wire) contains tungsten as a major component, and a predetermined proportion of potassium. The potassium content of the potassium-doped tungsten wire is at least 0.005 wt % and at most 0.010 wt % with respect to a total weight of potassium and tungsten.

The potassium-doped tungsten wire has a strength per an area of cross-section that increases with decreasing diameter φ. Accordingly, as with the case of the ReW alloy, use of the potassium-doped tungsten wire allows the surface of metal wire 100 to be resistant to scraping, and it is thus possible to easily reduce the surface roughness Ra. In other words, it is possible to easily manufacture metal wire 100 having the surface roughness Ra of at most 0.15 μm.

The elastic modulus, diameter, etc. of the ReW wire or the potassium-doped tungsten wire are respectively the same as those of metal wire 100 which contains tungsten.

(Others)

Although the saw wire and the cutting apparatus according to the present disclosure have been described based on the above-described embodiment and the variations thereof, the present disclosure is not limited to the above-described embodiment.

For example, although the case where nickel plating layer 110 is provided to the surface of metal wire 100 has been described in the above-described embodiment, the present disclosure is not limited to this example. A plurality of abrasive particles 130 may be fixed directly to metal wire 100.

In addition, for example, although cutting apparatus 1 of a fixed abrasive particle type in which abrasive particles 130 are fixed to metal wire 100 in advance has been described in the above-described embodiment, the present disclosure is not limited to this example. For example, cutting apparatus 1 may be of a free abrasive particle type. In this case, saw wire 10 is quite simply metal wire 100.

The stress applied to ingot 20 is more uniformed, with a decrease in the surface roughness Ra of saw wire 10, i.e., metal wire 100. Accordingly, it is possible to cut ingot 20 smoothly. Thus, when the surface roughness Ra is small, the oscillation width of saw wire 10 can be reduced as well. Accordingly, it is possible to reduce the kerb loss of ingot 20.

Moreover, cutting apparatus 1 is not limited to a multi-wire saw, and may be, for example, a wire sawing apparatus that, cuts out a wafer one by one by slicing ingot 20 using one wire saw 10. In addition, cutting apparatus 1 illustrated in FIG. 1 is merely an example, and thus need not include tension releasing device 4, for example.

It should be noted that the present disclosure also includes other forms in which various modifications apparent to those skilled in the art are applied to the embodiment or forms in which structural components and functions in the embodiment are arbitrarily combined within the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A saw wire, comprising:
a metal wire containing at least one of tungsten and a tungsten alloy, wherein
a surface roughness Ra of the metal wire is at most 0.16 μm, and
a diameter of the metal wire is at most 60 μm.

2. The saw wire according to claim 1, wherein
the tungsten alloy includes rhenium and tungsten, and
a rhenium content of the tungsten alloy is at least 0.1 wt % and at most 10 wt % with respect to a total weight of rhenium and tungsten.

3. The saw wire according to claim 1, wherein
the metal wire containing tungsten is doped with potassium, and
a potassium content of the metal wire is at most 0.010 wt % with respect to a total weight of potassium and tungsten.

4. The saw wire according to claim 3, wherein
the potassium content of the metal wire is at least 0.005 wt % with respect to the total weight of potassium and tungsten.

5. The saw wire according to claim 1, wherein
the surface roughness Ra of the metal wire is greater than 0.05 μm.

6. The saw wire according to claim 1, wherein
the diameter of the metal wire is at least 10 μm.

7. The saw wire according to claim 1, wherein
the diameter of the metal wire is uniform.

8. The saw wire according to claim 1, wherein
an elastic modulus of the metal wire is at least 350 GPa and at most 450 GPa.

9. The saw wire according to claim 1, further comprising:
a plurality of abrasive particles provided around a surface of the metal wire.

10. The saw wire according to claim 9, further comprising:
a nickel plating layer provided over the surface of the metal wire.

11. The saw wire according to claim 9, wherein
the plurality of abrasive particles include at least one of diamond and cubic boron nitride.

12. The saw wire according to claim 9, wherein
an average grain diameter of the plurality of abrasive particles is at most 10 μm.

13. A cutting apparatus, comprising the saw wire according to claim 1.

14. The cutting apparatus according to claim 13, further comprising:
a tension releasing device that releases tension exerted on the saw wire.

15. A method of slicing an ingot, the method comprising:
moving at least one saw wire relative to the ingot, each saw wire including a metal wire containing at least one of tungsten and a tungsten alloy, a surface roughness Ra of the metal wire being at most 0.15 μm, and a diameter of the metal wire being at most 60 μm; and
dividing the ingot at least into partly-sliced portions by the at least one saw wire.

16. A method of manufacturing a saw wire, the method comprising:
forming a metal wire containing at least one of tungsten and a tungsten alloy, wherein
a surface roughness Ra of the metal wire is at most 0.15 μm, and
a diameter of the metal wire is at most 60 μm.

17. The method according to claim 16, wherein
the forming includes repeatedly performing a plurality of processes in sequence, and
the plurality of processes includes a wire drawing process, a polishing process, and a die exchange process.
